(19) United States
(12) Patent Application Publication
(10) Pub. No.: US 2016/0028741 A1
(43) Pub. Date: Jan. 28, 2016

(54) METHODS AND DEVICES FOR VERIFICATION USING VERIFICATION CODE

(71) Applicant: Xiaomi Inc., Beijing (CN)

(72) Inventors: Hua Zhang, Beijing (CN); Yi Xia, Beijing (CN)

(21) Appl. No.: 14/598,239

(22) Filed: Jan. 16, 2015

Related U.S. Application Data
(63) Continuation of application No. PCT/CN2014/091620, filed on Nov. 19, 2014.

(30) Foreign Application Priority Data
Jul. 25, 2014 (CN) 201410360887.5

(51) Int. Cl. H04L 29/06; G06F 21/44; G06F 3/0486

(52) U.S. Cl. CPC H04L 63/12; G06F 3/0486; G06F 21/44

(57) ABSTRACT

The present disclosure relates to methods and devices for verification using a verification code. The method includes: generating acquiring information of the verification code for a current verification when receiving an acquiring request for the verification code from a terminal device, wherein the acquiring information of the verification code comprises a verification identifier, and an operation object and operation manner prompt information for acquiring the verification code; sending the acquiring information of the verification code to the terminal device; receiving a verification request from the terminal device, wherein the verification request comprises the verification identifier and a first verification code obtained after the operation object is operated according to the operation manner prompt information; and verifying the first verification code of the verification request. Accordingly, a user does not need to manually input the verification code, thus the verification manner is simplified.

### CROSS REFERENCE TO RELATED APPLICATIONS

This application is a Continuation Application of International Application PCT/CN2014/091620, with an international filing date of Nov. 19, 2014, which is based upon and claims priority to Chinese Patent Application No. 201410360887.5, filed on Jul. 25, 2014, the entire contents of which are incorporated herein by reference.

### TECHNICAL FIELD

The present disclosure generally relates to the field of Internet technology, and more particularly, to methods and devices for verification using a verification code.

### BACKGROUND

Currently, a verification code is generally needed for verification when a user uses a network application, and only when the verification is passed, the user may use the network application.

In the related art, an implementation manner of the verification code is mainly through user input, including input of figures, Chinese characters or the like.

### SUMMARY

The present disclosure provides methods and devices for verification using a verification code.

According to a first aspect of embodiments of the present disclosure, there provides a method for verification using a verification code in a server, including: generating acquiring information of the verification code for a current verification when receiving an acquiring request for the verification code from a terminal device, wherein the acquiring information of the verification code comprises a verification identifier, and an operation object and operation manner prompt information for acquiring the verification code; sending the acquiring information of the verification code to the terminal device; receiving a verification request from the terminal device, wherein the verification request comprises the verification identifier and a first verification code obtained after the operation object is operated according to the operation manner prompt information; and verifying the first verification code of the verification request.

According to a second aspect of the embodiments of the present disclosure, there provides a method for verification using a verification code in a terminal device, including: sending an acquiring request for the verification code to a server; obtaining acquiring information of the verification code for a current verification, wherein the acquiring information of the verification code comprises a verification identifier, and an operation object and operation manner prompt information for acquiring the verification code; receiving an operation acted on the operation object according to the operation manner prompt information; obtaining a first verification code according to the operation; and sending a verification request to the server, wherein the verification request comprises the verification identifier and the first verification code.

According to a third aspect of the embodiments of the present disclosure, there provides a server for verification using a verification code, including: a processor; a memory for storing instructions executable by the processor, wherein the processor is configured to perform: generating acquiring information of the verification code for a current verification when receiving an acquiring request for the verification code from a terminal device, wherein the acquiring information of the verification code comprises a verification identifier, and an operation object and operation manner prompt information for acquiring the verification code; sending the acquiring information of the verification code to the terminal device; receiving a verification request from the terminal device, wherein the verification request comprises the verification identifier and a first verification code obtained after the operation object is operated according to the operation manner prompt information; and verifying the first verification code of the verification request.

It is to be understood that both the foregoing general description and the following detailed description are exemplary and explanatory only and are not restrictive of the present disclosure.

### BRIEF DESCRIPTION OF THE DRAWINGS

The accompanying drawings, which are incorporated in and constitute a part of this specification, illustrate embodiments being consistent with the disclosure and, together with the description, serve to explain the principles of the disclosure.

FIG. 1 is a flow chart showing a method for verification using a verification code, according to an exemplary embodiment.

FIG. 2 is a flow chart showing a method for verification using a verification code, according to an exemplary embodiment.

FIG. 3 is a flow chart showing a method for verification using a verification code, according to an exemplary embodiment.

FIG. 4 is a flow chart showing a method for verification using a verification code, according to a detailed embodiment.

FIG. 5 is a diagram illustrating an interface of providing an operation object of a verification code, according to a detailed embodiment.

FIG. 6 is a diagram illustrating an interface of providing operation manner prompt information of a verification code, according to a detailed embodiment.

FIG. 7 is a flow chart showing a method for verification using a verification code, according to another detailed embodiment.

FIG. 8 is a block diagram illustrating an apparatus for verification using a verification code, according to an exemplary embodiment.

FIG. 9 is a block diagram illustrating a verification module in an apparatus for verification using a verification code, according to an exemplary embodiment.

FIG. 10 is a block diagram illustrating an apparatus for verification using a verification code, according to an exemplary embodiment.

FIG. 11 is a block diagram illustrating a second receiving module in an apparatus for verification using a verification code, according to an exemplary embodiment.

FIG. 12 is a block diagram illustrating a second acquiring module in an apparatus for verification using a verification code, according to an exemplary embodiment.

FIG. 13 is a block diagram illustrating a device for verification using a verification code, according to an exemplary embodiment.

FIG. 14 is a block diagram illustrating a device for verification using a verification code, according to an exemplary embodiment.

### DETAILED DESCRIPTION

Exemplary embodiments will be described in details herein, with examples thereof shown in drawings. In the following descriptions, when the drawings are referred to, unless expressed otherwise, the same number in different drawings refers to the same or similar elements. The implementation manners described in the exemplary embodiments below do not represent all implementation manners that are consistent with the present disclosure. On the contrary, they are only examples of devices and methods that are consistent with some aspects of the present disclosure as recited in the claims.

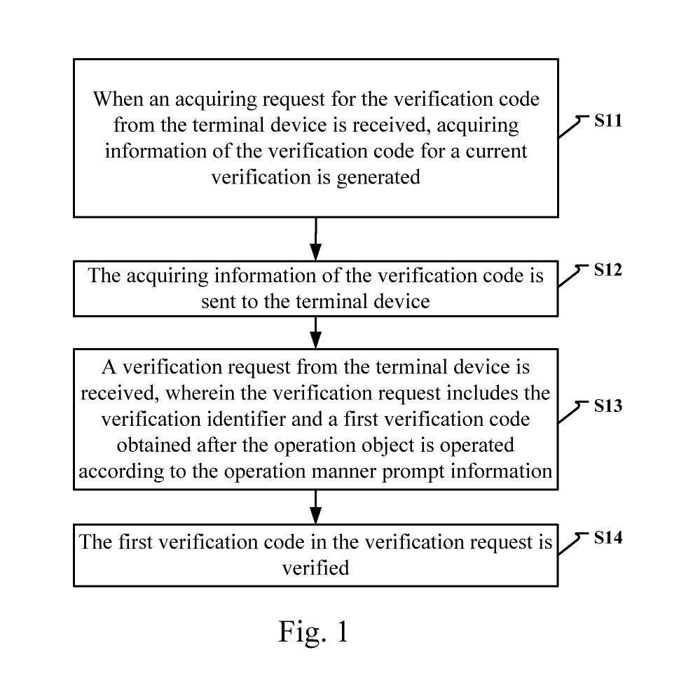

FIG. 1 is a flow chart showing a method for verification using a verification code, according to an exemplary embodiment. As shown in FIG. 1, the method for the verification using the verification code is applied in a server and includes the following steps.

In step S11, when an acquiring request for the verification code is received from the terminal device, acquiring information of the verification code for a current verification is generated. Herein the acquiring information of the verification code includes a verification identifier, and an operation object and operation manner prompt information for acquiring the verification code.

In step S12, the acquiring information of the verification code is sent to the terminal device.

In step S13, a verification request from the terminal device is received, wherein the verification request includes the verification identifier and a first verification code obtained after the operation object is operated according to the operation manner prompt information.

In step S14, the first verification code of the verification request is verified.

In the above described method, the terminal device may be a computer that uses a mouse, a cell phone or an iPad (tablet PC) that uses a touch screen or the like.

In step S11, the verification identifier may be an encrypted token.

Alternatively, before carrying out step S12, the above described method further includes steps of: operating the operation object according to the operation manner prompt information; and obtaining a second verification code. Before the server sends the acquiring information of the verification code to the terminal device, the server correctly operates the operation object according to the operation manner prompt information first, and then obtains and stores the second verification code.

Alternatively, step S14 may be carried out as the following steps.

In step S141, the second verification code is extracted according to the verification identifier.

In step S142, the first verification code is compared with the second verification code.

In step S143, whether the first verification code is the same as the second verification code is determined.

When the server verifies the first verification code in the verification request, the server may verify whether the first verification code is correct by comparing the first verification code with a pre-stored second verification code. When the first verification code is the same as the second verification code, the verification is passed; and when the first verification code is different from the second verification code, the verification is not passed.

After step S143, the server feeds back a verification result to the terminal device, which includes: All, when the verification is passed, sending verification passing information to the terminal device; and A12, when the verification is not passed, generating acquiring information of the verification code for a subsequent verification, and sending it to the terminal device.

Alternatively, the operation object of the verification code includes at least two characters, wherein each character corresponds to a separate movable image. The characters in the operation object are displayed in a form of image, and are displayed on the terminal device in a certain arrangement sequence.

When the operation object includes a plurality of separate movable images, the operation manner prompt information includes prompt information for dragging a specified character in the operation object to a specified position; and the first verification code includes position information of the characters after the character in the operation object is dragged. For example, the operation object includes four characters “A”, “B”, “C” and “D”, and the operation manner prompt information is to drag and switch positions of the characters “A” and “C”. Under the prompt of the operation manner, the characters “A” and “C” is dragged by the user, position information of the dragged characters is obtained. The position information is determined according to an arrangement sequence of the characters after the characters are dragged.

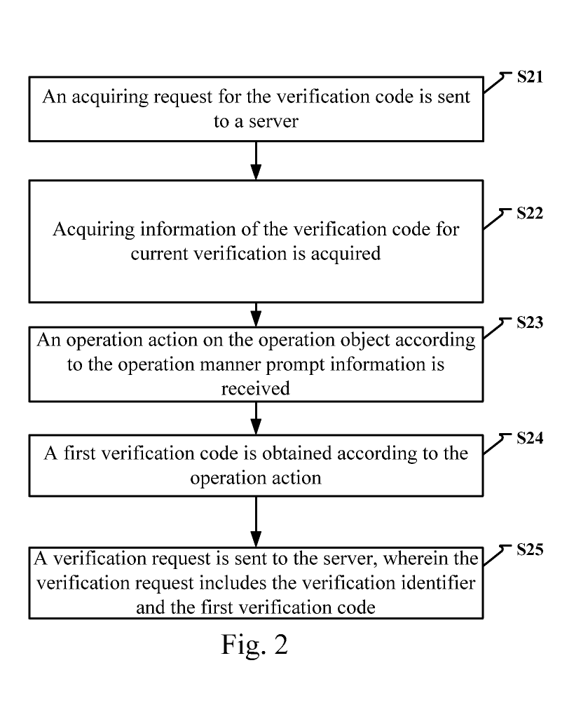

FIG. 2 is a flow chart showing a method for verification using a verification code, according to an exemplary embodiment. Referring to FIG. 2, the method includes the following steps.

In step S21, an acquiring request for the verification code is sent to a server.

In step S22, acquiring information of the verification code for a current verification is obtained. Herein the acquiring information of the verification code includes a verification identifier, and an operation object and operation manner prompt information for acquiring the verification code.

In step S23, an operation acted on the operation object according to the operation manner prompt information is received.

In step S24, a first verification code is obtained according to the operation.

In step S25, a verification request is sent to the server, wherein the verification request includes the verification identifier and the first verification code.

After step S22, the operation object and the operation manner prompt information of the verification code of the current verification acquired from the server are displayed on the terminal device, to allow a user to operate the operation object of the verification code.

Alternatively, in the above described method, the operation object of the verification code includes at least two characters, wherein each character corresponds to a separate movable image. When the operation object includes a plurality of separate movable images, the operation manner prompt information includes prompt information for dragging a specified character in the operation object to a specified position. At this time, step S23 may be carried out by receiving a dragging operation acted on the specified character in the operation object; and step S24 may be carried out by acquiring position information of the dragged character according to the dragging operation. The position information is determined according to an arrangement sequence of the characters dragging operation. For example, the operation object includes four characters “A”, “B”, “C” and “D”, and the operation manner prompt information is to drag and switch positions of the characters “A” and “C”. Before the characters “A” and “C” are dragged, position information of the four characters in the operation object correspond to 0x001, 0x002, 0x003 and 0x004, then after the characters “A” and “C” are dragged, the position information of the four characters in the operation object correspond to 0x003, 0x002, 0x001 and 0x004.

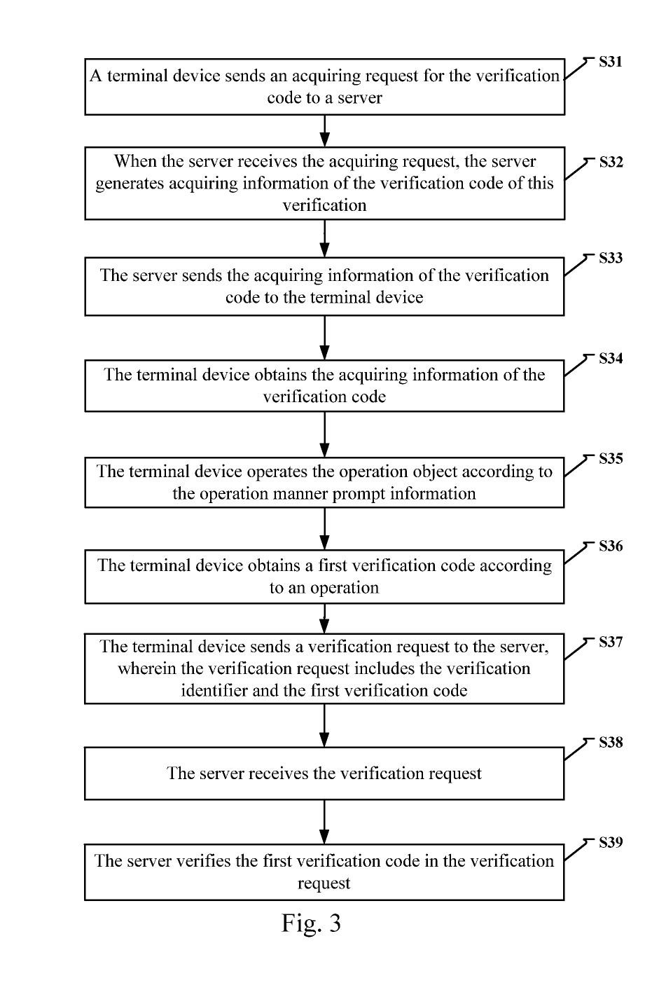

FIG. 3 is a flow chart showing a method for verification using a verification code, according to an exemplary embodiment. Referring to FIG. 3, the method includes the following steps.

In step S31, a terminal device sends an acquiring request for the verification code to a server.

In step S32, when the server receives the acquiring request, the server generates acquiring information of the verification code for a current verification, which includes a verification identifier, and an operation object and operation manner prompt information for acquiring the verification code.

In step S33, the server sends the acquiring information of the verification code to the terminal device.

In step S34, the terminal device obtains the acquiring information of the verification code.

In step S35, the terminal device operates the operation object according to the operation manner prompt information.

In step S36, the terminal device obtains a first verification code according to an operation.

In step S37, the terminal device sends a verification request to the server, wherein the verification request includes the verification identifier and the first verification code.

In step S38, the server receives the verification request.

In step S39, the server verifies the first verification code in the verification request.

Hereinafter, a method for verification using the verification code provided by the present disclosure will be explained by detailed embodiments.

### Embodiment 1

The terminal device in this embodiment maybe a computer that uses a mouse. As shown in FIG. 4, the method includes the following steps.

In step S401, an acquiring request for a verification code is sent from a user to a server by a click operation.

In step S402, the server receives the acquiring request sent from the user, and generates acquiring information of the verification code for a current verification, wherein the acquiring information of the verification code includes a verification identifier, and an operation object and operation manner prompt information of the verification code. For example, the operation object is a six character object including characters “A”, “B”, “C”, “D”, “E” and “F” that are arranged in this order in a form of image, corresponding position information is 0x001, 0x002, 0x003, 0x004, 0x005 and 0x006, and the operation manner prompt information is to drag and switch positions of the characters “C” and “D”.

In step S403, the server operates the operate object according to the operation manner prompt information, and obtains a second verification code “A”, “B”, “D”, “C”, “E” and “F”, and corresponding position information is 0x001, 0x002, 0x004, 0x003, 0x005 and 0x006.

In step S404, the server sends the generated acquiring information of the verification code to the terminal device.

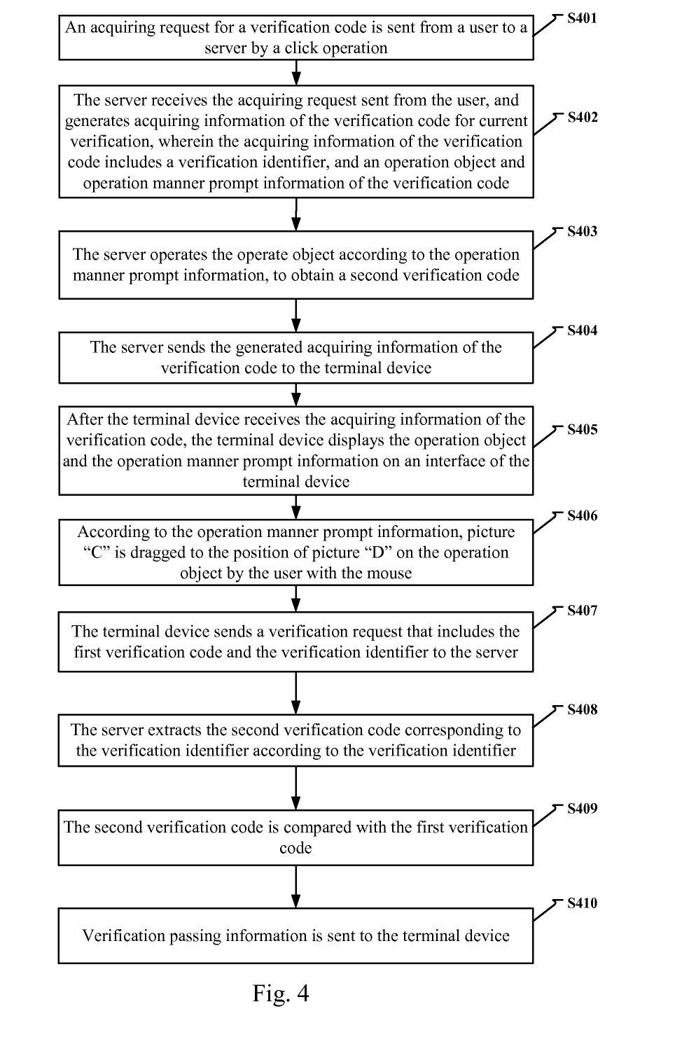

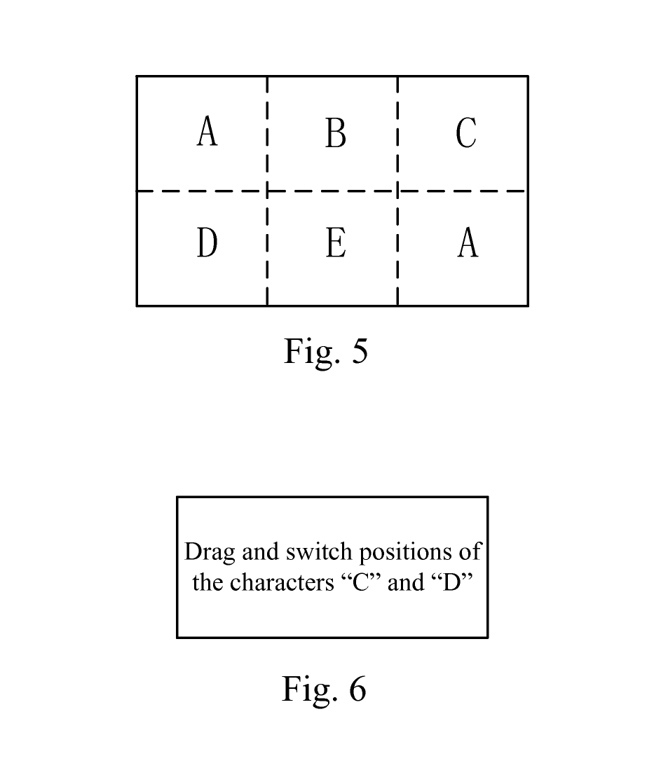

In step S405, after the terminal device receives the acquiring information of the verification code, the terminal device displays the operation object and the operation manner prompt information on an interface of the terminal device. As shown in FIGS. 5 and 6, the operation object and the operation manner prompt information are respectively displayed on the terminal device in the form of image.

In step S406, according to the operation manner prompt information, the positions of the characters “C” and “D” may be switched by dragging image “C” by the user to the position of image “D” on the operation object with the mouse, and then a first verification code “A”, “B”, “D”, “C”, “E” and “F” is obtained, and corresponding position information is 0x001, 0x002, 0x004, 0x003, 0x005 and 0x006.

In step S407, the terminal device sends a verification request that includes the first verification code and the verification identifier, to the server.

In step S408, the server extracts the second verification code corresponding to the verification identifier according to the verification identifier.

In step S409, the second verification code is compared with the first verification code, i.e., the position information of the second verification code 0x001, 0x002, 0x004, 0x003, 0x005 and 0x006 is compared with the position information of the first verification code 0x001, 0x002, 0x004, 0x003, 0x005 and 0x006.

In step S410, verification passing information is sent to the terminal device.

When the technical solution of the present embodiment is adopted, and according to the operation manner prompt information of the verification code, the operation object is dragged by clicking with the mouse, and the result obtained after dragging is verified, such that the user does not need to manually input the verification code, thus the verification manner is simplified, and verification failure caused by incorrect manual input by the user is avoided, verification efficiency of the verification code is increased, and the user experience is improved.

### Embodiment 2

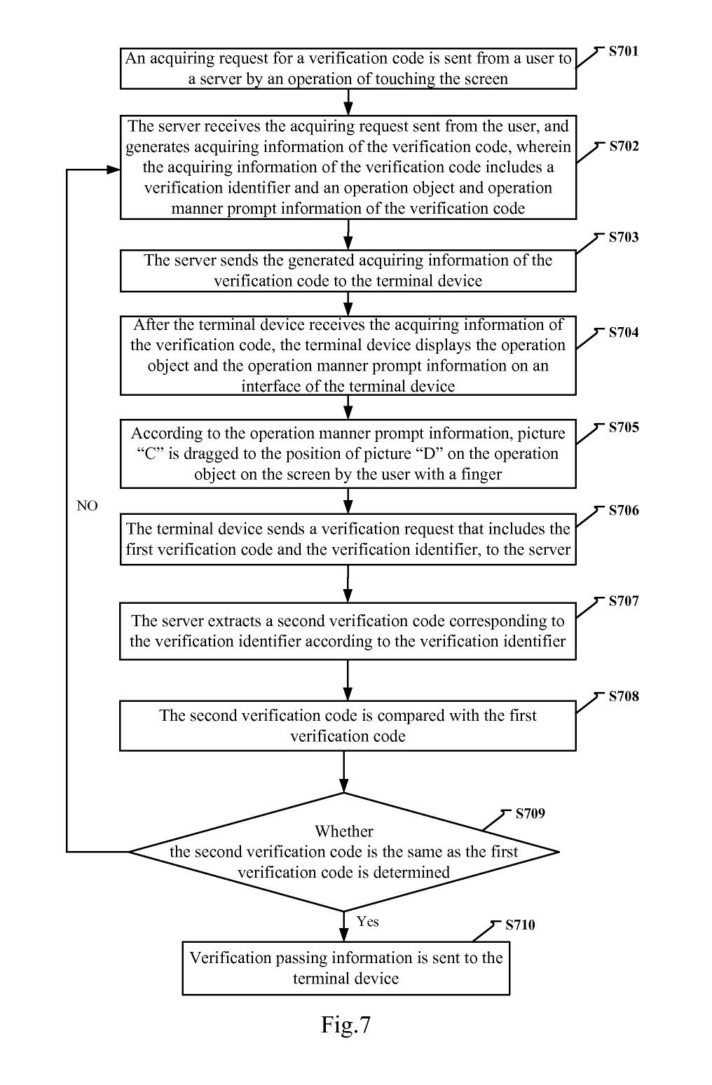

The terminal device in this embodiment is a tablet PC that uses a touch screen. As shown in FIG. 7, the method includes the following steps.

In step S701, an acquiring request for a verification code is sent from a user to a server by an operation of touching the touch screen.

In step S702, the server receives the acquiring request sent from the user, and generates acquiring information of the verification code, wherein the acquiring information of the verification code includes a verification identifier and an operation object and operation manner prompt information of the verification code. For example, the operate object is a six character object including characters “A”, “B”, “C”, “D”, “E” and “F” that are arranged in this order in a form of image, and the operation manner prompt information is to drag and switch positions of the characters “C” and “D”.

In step S703, the server sends the generated acquiring information of the verification code to the terminal device.

In step S704, after the terminal device receives the acquiring information of the verification code, the terminal device displays the operation object and the operation manner prompt information on an interface of the terminal device.

In step S705, according to the operation manner prompt information, the positions of the characters “C” and “D” may be switched by dragging image “C” by the user to the position of image “D” on the operation object with a finger, and then obtain a first verification code “A”, “B”, “D”, “C”, “E” and “F”.

In step S706, the terminal device sends a verification request, which includes the first verification code and the verification identifier, to the server.

In step S707, the server extracts a second verification code corresponding to the verification identifier according to the verification identifier.

In step S708, the second verification code is compared with the first verification code.

In step S709, whether the second verification code is the same as the first verification code is determined; and if the second verification code is the same as the first verification code, step S710 is performed; and if the second verification code is different from the first verification code, it returns step S702, and acquiring information of the verification code of a subsequent verification is generated.

When the technical solution of the present embodiment is adopted, and according to the operation manner prompt information of the verification code, the operation object is dragged with the finger of the user on the touch screen, and the result obtained after dragging is verified, such that the user does not need to manually input the verification code, thus the verification manner is simplified, and verification failure caused by incorrect manual input by the user is avoided, verification efficiency of the verification code is increased. Meanwhile, on the terminal device, such as the cell phone or the tablet PC, which are inconvenient to be operated, such an operation of dragging is simpler, thus the user experience is improved.

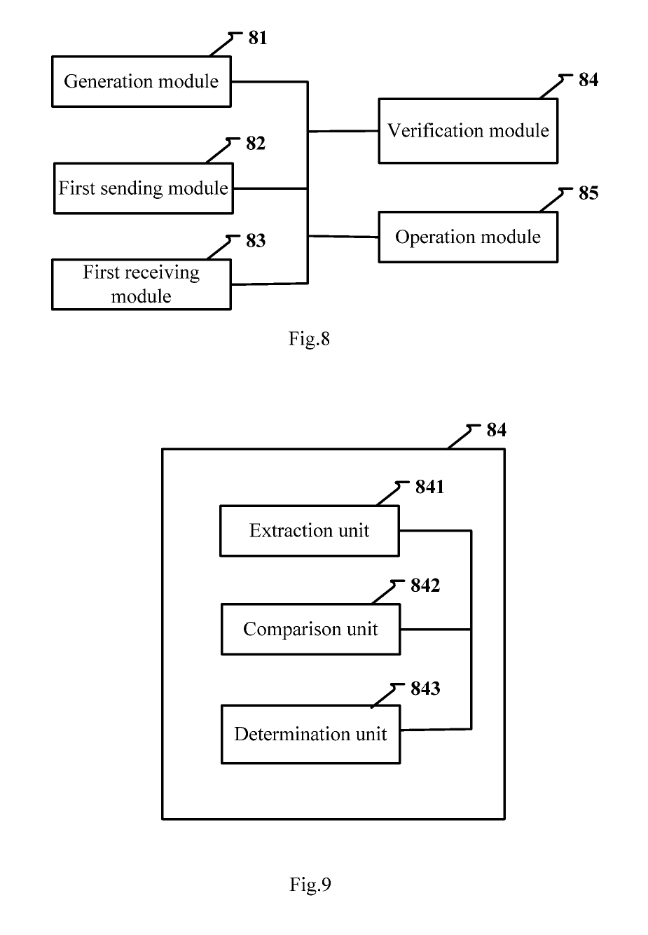

FIG. 8 is a block diagram illustrating an apparatus for verification using a verification code, according to an exemplary embodiment. Referring to FIG. 8, the apparatus includes: a generation module 81 configured to, when an acquiring request for the verification code from a terminal device is received, generate acquiring information of the verification code for a current verification, wherein the acquiring information of the verification code includes a verification identifier, and an operation object and operation manner prompt information for acquiring the verification code; a first sending module 82 configured to send the acquiring information of the verification code to the terminal device; a first receiving module 83 configured to receive a verification request from the terminal device, wherein the verification request includes the verification identifier and a first verification code obtained after the operation object is operated according to the operation manner prompt information; a verification module 84 configured to verify the first verification code in the verification request; and an operation module 85 configured to operate the operation object according to the operation manner prompt information, and to obtain a second verification code.

As shown in FIG. 9, the verification module 84 includes the following units: an extraction unit 841 configured to extract the second verification code according to the verification identifier; a comparison unit 842 configured to compare the first verification code with the second verification code; and a determination unit 843 configured to determine whether the first verification code is the same as the second verification code.

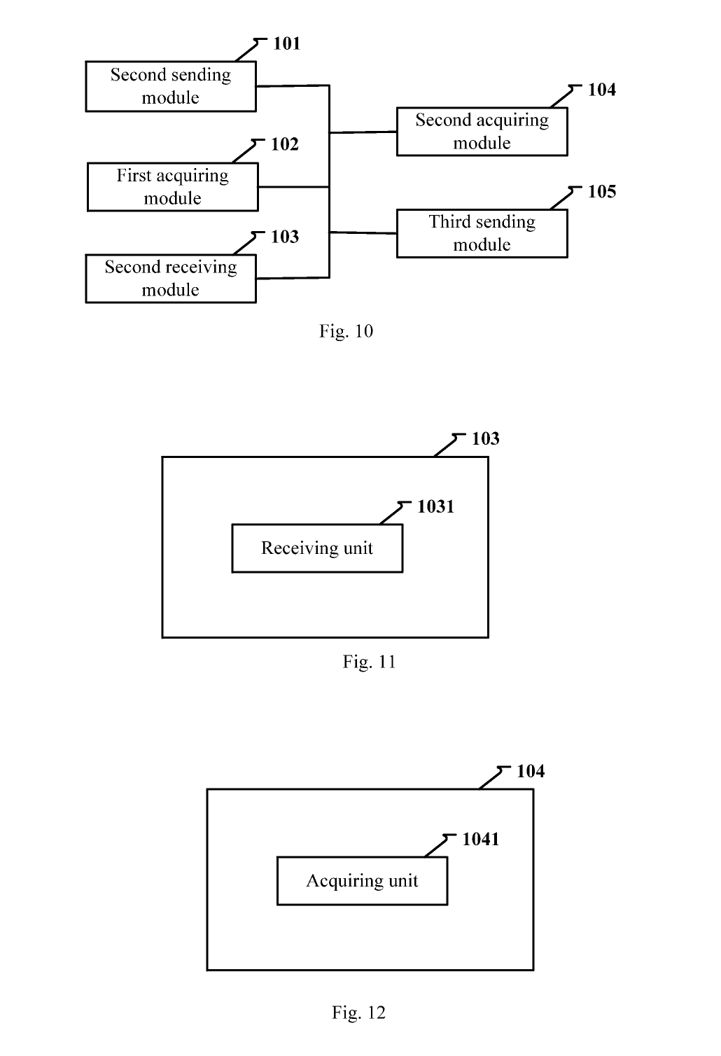

FIG. 10 is a block diagram illustrating an apparatus for verification using a verification code, according to an exemplary embodiment. Referring to FIG. 10, the apparatus includes: a second sending module 101 configured to send an acquiring request for the verification code to a server; a first acquiring module 102 configured to obtain acquiring information of the verification code for a current verification, wherein the acquiring information of the verification code includes a verification identifier, and an operation object and operation manner prompt information for acquiring the verification code; a second receiving module 103 configured to receive an operation acted on the operation object according to the operation manner prompt information; a second acquiring module 104 configured to obtain a first verification code according to the operation; and a third sending module 105 configured to send a verification request to the server, wherein the verification request includes the verification identifier and the first verification code.

As shown in FIG. 11, the second receiving module 103 includes the following units: a receiving unit 1031 configured to receive a dragging operation acted on a specified character in the operation object.

As shown in FIG. 12, the second acquiring module 104 includes the following unit: an acquiring unit 1041 configured to acquire position information of the dragged character according to the dragging operation.

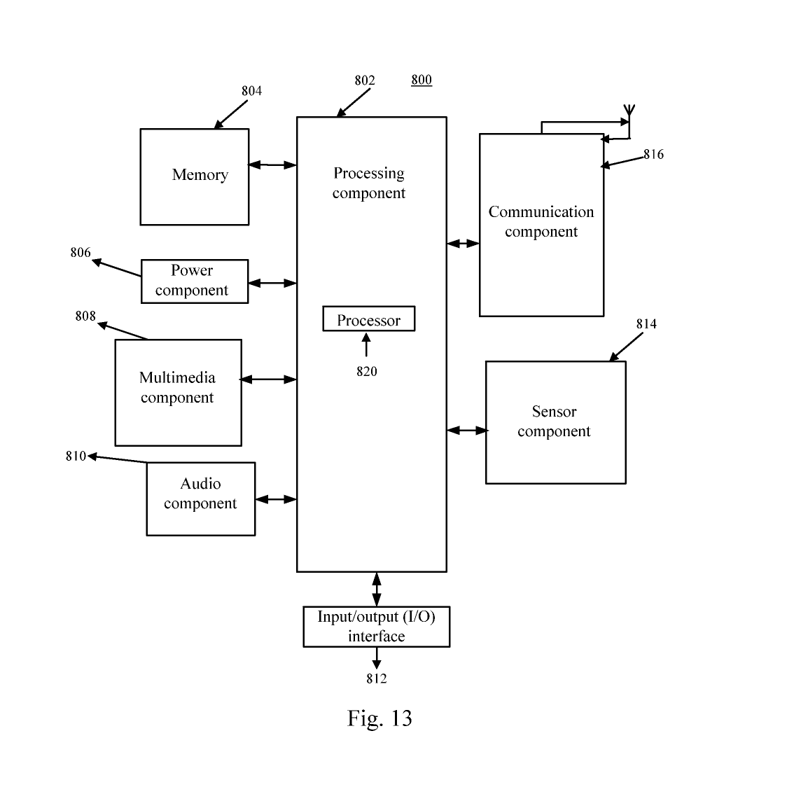

FIG. 13 is a block diagram illustrating a device 800 for verification using a verification code, according to an exemplary embodiment. The device 800 may be provided as the terminal device. Moreover, for example, the device 800 may be a mobile phone, a computer, a digital broadcast terminal device, a messaging device, a gaming console, a tablet, a medical device, exercise equipment, a personal digital assistant and the like.

Referring to FIG. 13, the device 800 may include one or more of the following components: a processing component 802, a memory 804, a power component 806, a multimedia component 808, an audio component 810, an input/output (I/O) interface 812, a sensor component 814, and a communication component 816.

The processing component 502 usually controls overall operations of the device 800, such as operations associated with display, telephone calls, data communications, camera operations and recording operations. The processing component 802 may include one or more processors 820 to execute instructions to perform all or a part of the steps in the above described methods. For example, the one or more processors 820 are configured to perform: sending an acquiring request for the verification code to a server; obtaining acquiring information of the verification code for a current verification, wherein the acquiring information of the verification code comprises a verification identifier, and an operation object and operation manner prompt information for acquiring the verification code; receiving an operation acted on the operation object according to the operation manner prompt information; obtaining a first verification code according to the operation; and sending a verification request to the server, wherein the verification request comprises the verification identifier and the first verification code.

Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operation of the device 800. Examples of such data include instructions for any application or method operated on the device 800, contact data, phonebook data, messages, pictures, videos, etc. The memory 804 may be implemented by any type of volatile or non-volatile memory device or combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or optical disk.

The power component 806 provides power to various components of the device 800. The power component 806 may include a power management system, one or more power sources, and other components associated with the generation, management, and distribution of power in the device 800.

The multimedia component 808 includes a screen for providing an output interface between the device 800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, slips, and gestures on the touch panel. The touch sensors may not only sense a boundary of a touch or slip action, but also sense a period of time and a pressure associated with the touch or slip action. In some embodiments, the multimedia component 808 includes a front camera and/or a rear camera. The front camera and/or the rear camera may receive external multimedia data while the device 800 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a microphone (MIC) configured to receive an external audio signal when the device 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface between the processing component 802 and peripheral interface modules, such as a keyboard, a click wheel, a button, and the like. The button may include, but not limited to: a home button, a volume button, a starting button and a locking button.

The sensor component 814 includes one or more sensors to provide status assessments of various aspects of the device 800. For instance, the sensor component 814 may detect an open/closed status of the device 800, relative position of components, e.g., the display and the keyboard, of the device 800, a change in position of the device 800 or a component of the device 800, a presence or absence of an user contact with the device 800, an orientation or an acceleration/deceleration of the device 800, and a change in temperature of the device 800. The sensor component 814 may include a proximity sensor configured to detect the presence of nearby objects without any physical contact. The sensor component 814 may further include a light sensor, such as a CMOS or CCD image sensor, for use in imaging applications. In some embodiments, the sensor component 814 may further include an accelerometer sensor, a gyroscope sensor, a magnetic sensor, a pressure sensor, or a temperature sensor.

The communication component 816 is configured to facilitate communication, in a wire or wireless manner, between the device 800 and other devices. The device 800 can access a wireless network based on a communication standard, such as WiFi, 2G or 3G, or a combination thereof. In one exemplary embodiment, the communication component 816 receives a broadcast signal or broadcast associated information from an external broadcast management system via a broadcast channel. In one exemplary embodiment, the communication component 816 further includes a near field communication (NFC) module to facilitate short-range communications. For example, the NFC module may be implemented based on a radio frequency identification (RFID) technology, an infrared data association (IrDA) technology, an ultra-bandwidth (UWB) technology, a Bluetooth (BT) technology, and other technologies.

In exemplary embodiments, the device 800 may be implemented by one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors or other electronic components, for performing the above described methods.

In exemplary embodiments, there further provides a non-transitory computer readable storage medium including instructions, such as included in the memory 804, executable by the processor 820 in the device 800, for performing the above described methods. For example, the non-transitory computer-readable storage medium may be a ROM, a random access memory (RAM), a CD-ROM, a magnetic tape, a floppy disc, an optical data storage device and the like.

There provides a non-transitory computer readable storage medium, when instructions in the storage medium are executed by processors of the terminal device, the terminal device can execute a method for verification using a verification code, including: sending an acquiring request for the verification code to a server; obtaining acquiring information of the verification code for a current verification, wherein the acquiring information of the verification code comprises a verification identifier, and an operation object and operation manner prompt information for acquiring the verification code; receiving an operation acted on the operation object according to the operation manner prompt information; obtaining a first verification code according to the operation; and sending a verification request to the server, wherein the verification request comprises the verification identifier and the first verification code.

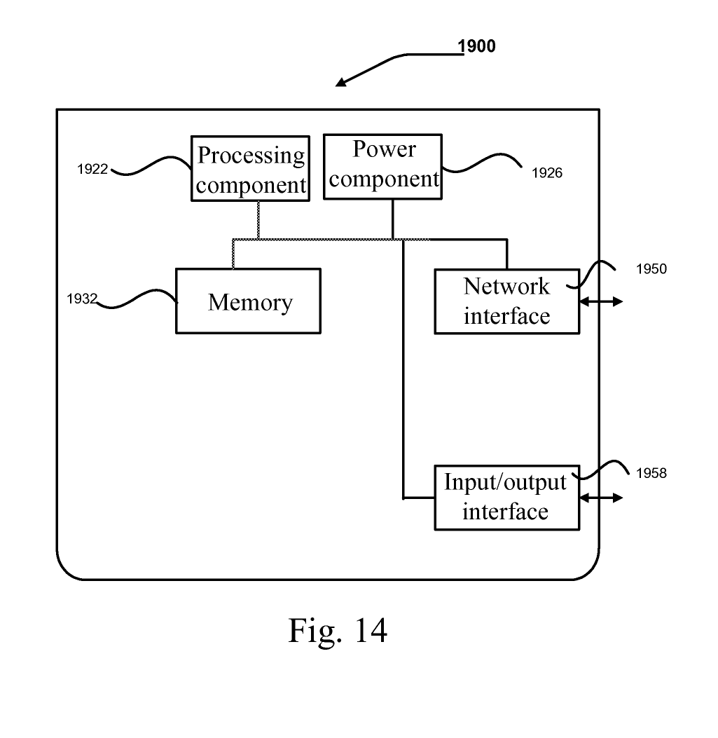

FIG. 14 is a block diagram illustrating a device 1900 for verification using a verification code, according to an exemplary embodiment. For example, the device 1900 may be provided as a server. Referring to FIG. 14, the device 1900 includes a processing component 1922 that further includes one or more processors, and memory resources represented by a memory 1932 for storing instructions executable by the processing component 1922, such as application programs. The application programs stored in the memory 1932 may include one or more modules each corresponding to a set of instructions. Further, the processing component 1922 is configured to execute the instructions to perform the above described methods. For example, the processing component 1922 is configured to perform: generating acquiring information of the verification code for a current verification when receiving an acquiring request for the verification code from a terminal device, wherein the acquiring information of the verification code comprises a verification identifier, and an operation object and operation manner prompt information for acquiring the verification code; sending the acquiring information of the verification code to the terminal device; receiving a verification request from the terminal device, wherein the verification request comprises the verification identifier and a first verification code obtained after the operation object is operated according to the operation manner prompt information; and verifying the first verification code of the verification request.

The device 1900 may further include one power component 1926 configured to perform power management of the device 1900, one wired or wireless network interface 1950 configured to connect the device 1900 to a network, and one input/output (I/O) interface 1958. The device 1900 may operate based on an operating system stored in the memory 1932, such as Windows Server™, Mac OS X™, Unix™, Linux™, FreeBSD™, or the like.

There provides a non-transitory computer readable storage medium, when instructions in the storage medium are executed by processors of the server, the server can execute a method for verification using a verification code, including: generating acquiring information of the verification code for a current verification when receiving an acquiring request for the verification code from a terminal device, wherein the acquiring information of the verification code comprises a verification identifier, and an operation object and operation manner prompt information for acquiring the verification code; sending the acquiring information of the verification code to the terminal device; receiving a verification request from the terminal device, wherein the verification request comprises the verification identifier and a first verification code obtained after the operation object is operated according to the operation manner prompt information; and verifying the first verification code of the verification request.

After considering this description and carrying out the disclosure herein, those skilled in the art will easily anticipate other implementation aspects of the present disclosure. The present application is meant to cover any variations, usage or adaptive change of the present disclosure, and these variations, usage or adaptive change follow general concept of the present disclosure and include the common knowledge or the customary technical means in the technical field that is not disclosed in the present disclosure. The description and embodiments are only exemplary, and the real range and spirit of the present disclosure are defined by the following claims.

It should be understood that the present disclosure is not limited to precise structures that are described above and shown in the accompanying drawings, and may be modified and changed without departing from the range of the present disclosure. The scope of the present disclosure is only defined by the appended claims.

What is claimed is:

1. A method for verification using a verification code in a server, comprising:
generating acquiring information of the verification code for a current verification when receiving an acquiring request for the verification code from a terminal device, wherein the acquiring information of the verification code comprises a verification identifier, and an operation object and operation manner prompt information for acquiring the verification code;
sending the acquiring information of the verification code to the terminal device;
receiving a verification request from the terminal device, wherein the verification request comprises the verification identifier and a first verification code obtained after the operation object is operated according to the operation manner prompt information; and
verifying the first verification code of the verification request.

2. The method according to claim 1, wherein, before sending the verification identifier to the terminal device, the method further comprises:
operating the operation object according to the operation manner prompt information; and
obtaining a second verification code.

3. The method according to claim 2, wherein verifying the first verification code of the verification request comprises:
extracting the second verification code according to the verification identifier;
comparing the first verification code with the second verification code; and
determining whether the first verification code is the same as the second verification code.

4. The method according to claim 1, wherein the operation object comprises at least two characters, wherein each character corresponds to a separate movable image.

5. The method according to claim 4, wherein the operation manner prompt information comprises prompt information for dragging a specified character in the operation object to a specified position, and the first verification code is obtained by using position information of the characters after the specified character is dragged.

6. The method according to claim 5, wherein the position information is determined according to an arrangement sequence of the characters after the specified character is dragged.

7. A method for verification using a verification code in a terminal device, comprising:
sending an acquiring request for the verification code to a server;
obtaining acquiring information of the verification code for a current verification, wherein the acquiring information of the verification code comprises a verification identifier, and an operation object and operation manner prompt information for acquiring the verification code;
receiving an operation acted on the operation object according to the operation manner prompt information;
obtaining a first verification code according to the operation; and
sending a verification request to the server, wherein the verification request comprises the verification identifier and the first verification code.

8. The method according to claim 7, wherein the operation object comprises at least two characters, wherein each character corresponds to a separate movable image.

9. The method according to claim 7, wherein the operation manner prompt information comprises prompt information for dragging a specified character in the operation object to a specified position, and receiving the operation acted on the operation object according to the operation manner prompt information comprises:
receiving a dragging operation acted on the specified character in the operation object.

10. The method according to claim 7, wherein obtaining the first verification code according to the operation comprises:
acquiring position information of the characters according to the dragging operation.

11. The method according to claim 10, wherein the position information is determined according to an arrangement sequence of the characters after the specified character is dragged.

12. A server for verification using a verification code, comprising:
a processor;
a memory for storing instructions executable by the processor, wherein the processor is configured to:
generating acquiring information of the verification code for a current verification when receiving an acquiring request for the verification code from a terminal device, wherein the acquiring information of the verification code comprises a verification identifier, and an operation object and operation manner prompt information for acquiring the verification code;
sending the acquiring information of the verification code to the terminal device;
receiving a verification request from the terminal device, wherein the verification request comprises the verification identifier and a first verification code obtained after the operation object is operated according to the operation manner prompt information; and
verifying the first verification code of the verification request.

13. The server according to claim 12, wherein, before sending the verification identifier to the terminal device, the processor is configured to further perform:
operating the operation object according to the operation manner prompt information; and
obtaining a second verification code.

14. The server according to claim 13, wherein verifying the first verification code of the verification request comprises:
extracting the second verification code according to the verification identifier;
comparing the first verification code with the second verification code; and
determining whether the first verification code is the same as the second verification code.

15. The server according to claim 12, wherein the operation object comprises at least two characters, wherein each character corresponds to a separate movable image.

16. The server according to claim 15, wherein the operation manner prompt information comprises prompt information for dragging a specified character in the operation object to a specified position, and the first verification code is obtained by using position information of the characters after the specified character is dragged.

17. The server according to claim 16, wherein the position information is determined according to an arrangement sequence of the characters after the specified character is dragged.
